(19) United States
(12) Patent Application Publication
(10) Pub. No.: US 2019/0333709 A1
(43) Pub. Date: Oct. 31, 2019

(54) METHOD FOR THE PRODUCTION OF A CYLINDRICAL HYBRID SUPERCAPACITOR COMPRISING AN IONIC ALKALI METAL

(71) Applicant: BLUE SOLUTIONS, ERGUE GABERIC (FR)

(72) Inventors: Olivier CAUMONT, QUIMPER (FR); Thierry DREZEN, PONT L'ABBE (FR)

(21) Appl. No.: 16/319,429

(22) PCT Filed: Jul. 24, 2017
(86) PCT No.: PCT/FR2017/052043

§ 371 Date: Jan. 21, 2019

(30) Foreign Application Priority Data
Jul. 25, 2016 (FR) 1657106

(51) Int. Cl. H01G 11/06; H01G 11/84; H01G 11/80; H01G 11/82; H01G 11/52; H01G 11/50; H01G 11/28; H01G 11/62; H01G 11/32; H01G 11/24; H01G 11/68; H01G 11/46

(52) U.S. Cl. CPC H01G 11/06; H01G 11/84; H01G 11/80; H01G 11/82; H01G 11/52; H01G 11/46; H01G 11/28; H01G 11/62; H01G 11/32; H01G 11/24; H01G 11/68; H01G 11/50

(57) ABSTRACT

The invention relates to a process for the preparation of a cylindrical alkali metal-ion hybrid supercapacitor and to a cylindrical alkali metal-ion hybrid supercapacitor obtained according to said process.

The invention relates to a process for the preparation of a cylindrical alkali metal-ion hybrid supercapacitor and to a cylindrical alkali metal-ion hybrid supercapacitor obtained according to said process.

A lithium-ion (Li-ion) hybrid supercapacitor combines the principles of storage of a lithium-ion battery and of an electrochemical double layer capacitor (EDLC) and has a high energy density, generally of the order of 13 or 14 Wh·kg⁻¹, in a standard EDLC. A symmetrical cell of a standard EDLC is composed of two identical capacitive electrodes (carbon electrodes having very high specific surfaces, generally between 1000 and 2000 m²·g⁻¹) deposited on metal current collectors, between which a porous separator ensures electronic insulation. The assembly is immersed in an electrolyte. The difference in potential of such an uncharged cell is 0 V and it increases linearly with time during the galvanostatic charging of the direct current cell. During the charging, the potential of the positive electrode increases linearly and the potential of the negative electrode decreases linearly. During the discharging, the cell voltage decreases linearly. Industrial symmetrical EDLCs operating in an organic medium usually have a nominal voltage of the order of 2.7 V. In contrast, the negative electrode of lithium-ion battery type is characterized by a virtually constant potential during the charging and discharging of the system, in the case of a Li-ion supercapacitor. In order to increase the operating voltage of a supercapacitor and thus its energy density, hybrid supercapacitors in which the negative electrode of an EDLC is replaced with a carbon electrode of “lithium-ion battery” type have been proposed.

The main problems to be solved in this type of hybrid supercapacitor are the formation of the passivation layer and the intercalation/insertion of the lithium into the negative electrode. During the first cycle of insertion of the lithium ions, the passivation of the negative electrode makes possible the formation of an intermediate layer at the surface of this electrode. In the presence of this passivation layer, the lithium ions are desolvated before being intercalated/inserted into the negative electrode. The presence of a well formed passivation layer makes it possible to prevent the exfoliation of the planes of the carbon of the negative electrode by the insertion of the solvent with the lithium during the cycling of the system. The lithium is intercalated/inserted into the negative electrode until an Li_{˜x}C₆ composition with 0.5<x<1 is achieved. During operation, x remains between 0.5 and 1 and, for this reason, the potential of the negative electrode remains relatively stable during the successive charges/discharges of the hybrid supercapacitor.

In the state of the art, it is known to add, to a hybrid supercapacitor, a source of lithium metal in order to produce the passivation layer and to intercalate/insert a sufficient amount of lithium ions into the negative electrode. In particular, during the assembling of a hybrid supercapacitor, one or more lithium sheets are inserted into the stack of the different layers of positive electrodes, of negative electrodes and of separators, for example at the beginning, at the end and/or in the middle of the stack. During a preliminary (and necessary) formation stage (i.e. initial formation stage), lithium ions originating from the lithium sheets inserted into the stack are intercalated into the negative electrodes. Once all of the lithium has been consumed, the lithium-ion supercapacitor can be charged and discharged. However, this method exhibits the disadvantages mentioned below. First of all, it is necessary to provide the exact amount of lithium metal to be contributed to the hybrid supercapacitor in order, on the one hand, for this amount to be sufficient to form all the negative electrodes of said hybrid supercapacitor and, on the other hand, for it to be completely consumed after the preliminary formation stage in the hybrid supercapacitor. This is because the presence of lithium metal after the preliminary formation stage can result in the formation of dendrites during the subsequent cycles and in a short circuit of the system. Furthermore, the insertion of lithium sheets during the assembling of the supercapacitor renders the assembling process complex and expensive. This is because the number of stages is increased with respect to a conventional assembling process; the assembling has to be carried out under a humidity-controlled atmosphere in order to prevent the degradation of the lithium metal during its insertion into the stack, and, as explained above, the amount of lithium metal to be inserted has to be calibrated, bringing about the use of a series of preliminary tests and calculations before the assembling, which has to be repeated if one of the parameters of the cell is modified (e.g., thicknesses of the electrodes, types of electrodes, and the like).

By way of example, the document EP 1 400 996 describes the interposition of a sacrificial source of lithium metal into a hybrid supercapacitor composed of a stack or of a winding of layers of positive electrode(s), of negative electrode(s) and of separator(s). The amount of lithium metal introduced into said hybrid supercapacitor is calculated so that a) the capacity of the negative electrode per unit of weight of the negative electrode active material is at least three times greater than the capacity of the positive electrode per unit of weight of the positive electrode active material, and b) the weight of the positive electrode active material is greater than the weight of the negative electrode active material. When the hybrid supercapacitor is composed of a winding of layers of positive electrode, of negative electrode and of separator, a lithium sheet can be attached by pressure to the current collector of the negative electrode of the outermost layer of the winding or positioned at the centre of the winding. In the first case, the penetration of the electrolyte within the winding after the assembling may be slowed down since the winding is covered with the lithium source; the electrolyte will thus with difficulty be diffused inside the winding. In the second case, it is not described how and at what moment the lithium metal is introduced at the centre of the winding. Neither is it described how the lithium metal is electrically connected in the hybrid supercapacitor.

The document JP 2007067105 describes a process for the preparation of a hybrid supercapacitor in which lithium metal is positioned at the centre of a winding of electrodes and of separators. In particular, the layers of positive electrode, of negative electrode and of separator are wound and then lithium metal is placed at the centre of the winding. The lithium metal is in the form of a sheet of lithium wound around a metal rod acting as a current collector (e.g., nickel, steel), of a winding of a layer of lithium metal and of a porous layer of current collector (e.g., copper) or of a cylindrical tube of lithium metal inserted into a porous cylindrical tube of current collector. The electrolyte is then added, the supercapacitor is hermetically closed and a preliminary formation stage (or initial formation stage) is carried out in order to intercalate lithium ions into the negative electrode. Here again, the amount of lithium metal is calibrated so as to prevent the residual presence of lithium metal at the end of the 1^{st} charging cycle. Furthermore, the presence of lithium metal at the centre may hinder the impregnation of the electrodes by the electrolyte. Finally, the support of the lithium metal at the centre of the winding occupies a portion of the free volume normally intended to collect the overpressure generated by the gases formed during the electrical ageing of the supercapacitor.

Thus, the aim of the present invention is to overcome the disadvantages of the abovementioned prior art and to provide a process for the preparation of a hybrid supercapacitor which is economical and simple, in particular in which the arrangement of the source of lithium metal is simplified, and which makes it possible to avoid any prior calibration of the mass of lithium metal to be used.

A subject-matter of the invention is a process for the preparation of a cylindrical alkali metal-ion hybrid supercapacitor comprising at least one cylindrical coiled element and an external casing containing a main body intended to receive said cylindrical coiled element, said process comprising at least the following stages:

i) the preparation of a cylindrical coiled element centred on an X-X axis comprising at least one positive electrode, at least one negative electrode and at least one separator intercalated between the positive and negative electrodes, the positive and negative electrodes and the separator being wound together as turns around said X-X axis, the cylindrical coiled element having a central free volume along the X-X axis, it being understood that:
the positive electrode comprises at least one positive electrode active material capable of intercalating and of deintercalating ions of an alkali metal M1 and/or capable of adsorbing and of desorbing ions of an alkali metal M1, said positive electrode being deposited on a positive electrode current collector, and
said negative electrode comprises at least one negative electrode active material capable of intercalating and of deintercalating ions of an alkali metal M1, said negative electrode being deposited on a negative electrode current collector,

ii) the insertion of the cylindrical coiled element into a main body of an external casing intended to receive said cylindrical coiled element,

iii) the impregnation of the cylindrical coiled element by a non-aqueous liquid electrolyte comprising a salt of said alkali metal M1 and an organic solvent, said process being characterized in that it additionally comprises:

iv) the insertion of a solid mass comprising said alkali metal M1 into the central free volume of the cylindrical coiled element, before or after stage iii),

v) the electrical connection of the solid mass with the negative electrode, so as to obtain a short circuit and to intercalate ions of said alkali metal M1 into the negative electrode of the cylindrical coiled element,

vi) the withdrawal of the solid mass from the cylindrical coiled element, and

vii) the hermetic closure of the main body of the external casing, in order to obtain the cylindrical alkali metal-ion hybrid supercapacitor.

The process of the invention is simple and economical. It makes it possible to intercalate a sufficient amount of alkali metal into the negative electrode while preventing any risk of formation of dendrites and/or of short circuit brought about by the presence of residual alkali metal in the supercapacitor. This is because, on the one hand, stage v) is a preliminary stage of formation of the negative electrodes, also known as initial formation stage. Thus, on conclusion of stage v) or vi), the negative electrodes of the hybrid supercapacitor are ready for use for the charge and discharge cycles. Moreover, the alkali metal M1 present at the centre of the coiled element (i.e., of the spirally wound assemblage of electrodes) is withdrawn from the supercapacitor [stage vi)] from the formation of the negative electrodes [i.e., after stage v)] and before the hermetic (and definitive) closure of the supercapacitor [i.e., before stage vii)]. Furthermore, as the alkali metal M1 is withdrawn, the free volume at the centre of the supercapacitor resulting from this withdrawal can be used to contain the gases generated during the electrical ageing of the supercapacitor by charge/discharge cycles (cyclings) or by maintaining at constant voltage (floatings) and thus to limit/delay the possible swelling of the supercapacitor.

Stage i) can comprise a substage i-1) of assembling at least one positive electrode, at least one negative electrode and at least one separator intercalated between the negative electrode and the positive electrode, and a substage i-2) of winding the assemblage spirally around an X-X axis in order to form a cylindrical coiled element having a central free volume along the X-X axis.

The central free volume along the X-X axis is delimited by the innermost turn of the cylindrical coiled element.

In the processes of the prior art, this central volume can, for example, be occupied by a central solid support (for example, a core) in order to facilitate the coiling or the winding (i.e., non-free volume).

In the process of the invention, the substage i-2) [or more generally stage i)] is preferably carried out without a central solid support.

However, it is possible to carry out substage i-2) with such a central solid support, provided that a subsequent substage i-3) of withdrawal of said central solid support is carried out before stage iv). This substage i-3) thus makes it possible to release the central volume of the cylindrical coiled element before carrying out stage iv).

On conclusion of stage i), the cylindrical coiled element is in a configuration such that the current collector of the positive electrode protrudes at one end of said coiled element (i.e., “protruding” or “extending” positive current collector) and the current collector of the negative electrode protrudes at the other end (i.e., opposite end) of said coiled element (i.e., “protruding” or “extending” negative current collector).

This is because the cylindrical coiled element is delimited at its two opposite ends, respectively, by two current collecting turns.

According to a particularly preferred embodiment of the invention, the cylindrical coiled element centred on an X-X axis additionally comprises a separator deposited on the positive electrode or on the negative electrode. This thus makes it possible, during stage i), to obtain the following elements: positive electrode/separator/negative electrode/separator or separator/positive electrode/separator/negative electrode wound together as turns around said X-X axis.

The coiled element can additionally comprise a layer of said alkali metal M1 on at least one of the faces of the protruding negative current collector.

The protruding negative current collector is preferably perforated.

In a specific embodiment, the active material of the negative electrode comprises a carbon-based material.

The carbon-based material of the negative electrode is preferably chosen from graphene, graphite, low-temperature carbons (hard or soft), carbon black, carbon nanotubes and carbon fibres.

The specific surface (B.E.T. method) of the carbon-based material of the negative electrode is preferably less than 50 m²/g approximately.

The negative electrode preferably has a thickness varying from 10 to 100 μm approximately.

According to a particularly preferred embodiment of the invention, the active material of the negative electrode comprises graphite and optionally a material chosen from activated carbon, graphene, carbide-derived carbon, hard carbon and soft carbon.

In a specific embodiment, the active material of the positive electrode comprises a porous carbon-based material or a transition metal oxide.

The transition metal oxide of the positive electrode is preferably chosen from MnO₂, SiO₂, NiO₂, TIO₂, RuO₂ and VNO₂.

The porous carbon-based material is preferably chosen from activated carbons, carbide-derived carbon (CDC), porous carbon nanotubes, porous carbon blacks, porous carbon fibres, carbon onions and carbons derived from coke (the porosity of which is increased by charging).

According to a preferred embodiment of the invention, the specific surface of the porous carbon-based material of the positive electrode varies from 1200 to 3000 m²/g approximately (B.E.T. method) and preferably from 1200 to 1800 m²/g approximately (B.E.T. method).

According to a particularly preferred embodiment of the invention, the active material of the positive electrode comprises activated carbon and optionally material chosen from graphite, graphene, carbide-derived carbon, hard carbon and soft carbon.

The positive electrode preferably has a thickness varying from 50 to 150 μm approximately.

Besides the active material, the positive electrode (respectively the negative electrode) generally comprises at least one binder.

The binder can be chosen from organic binders conventionally known to a person skilled in the art and electrochemically stable up to a potential of 5 V vs the alkali metal M1 (e.g., Li). Mention may in particular be made, among such binders, of:
homopolymers and copolymers of vinylidene fluoride, such as poly(vinylidene fluoride) (PVDF),
copolymers of ethylene, of propylene and of a diene,
homopolymers and copolymers of tetrafluoroethylene,
homopolymers and copolymers of N-vinylpyrrolidone,
homopolymers and copolymers of acrylonitrile, or
homopolymers and copolymers of methacrylonitrile.

When it is present, the binder preferably represents from 1 to 15% by weight approximately, with respect to the total weight of the electrode.

The positive electrode (respectively the negative electrode) can additionally comprise at least one agent conferring an electron conductivity.

The agent conferring electron conduction properties can be carbon, preferably chosen from carbon blacks, such as acetylene black, carbon blacks having a high specific surface, such as the products sold under the name Ketjenblack® EC-600JD by Akzo Nobel, carbon nanotubes, graphite, graphene or mixtures of these materials.

According to the invention, when it is present, the material conferring electron conduction properties preferably represents from 1 to 10% by weight approximately, with respect to the total weight of the electrode.

The active material, the binder and the agent conferring electron conduction properties form the electrode and the latter is deposited on the corresponding current collector.

The current collector of the negative electrode can be a current collector made of conducting material, in particular of copper.

The current collector of the positive electrode can be a current collector made of conducting material, in particular of aluminium.

The separator is generally made of a porous material which is not an electron conductor, for example made of a polymer material based on polyolefins (e.g., polyethylene, polypropylene) or made of fibres (e.g., glass fibres, wood fibres or cellulose fibres).

Mention may be made, as example of separators made of polymer material based on polyolefins, of those sold under the Celgard® reference.

The main body of the external casing can have a lower part and an upper part.

Stage ii) can be carried out so as to position the protruding current collector of the positive electrode in the lower part of the main body of the external casing and the protruding current collector of the negative electrode in the upper part of the main body of the external casing.

Stage ii) can also comprise a substage ii-1) during which the protruding current collector of the negative electrode is electrically connected to a part made of conducting material, preferably by welding (e.g., using laser welding by transparency), brazing, diffusion brazing or clamped or screwed contacts. The technique of laser welding by transparency makes it possible to electrically connect all the turns of the coiled element.

Stage ii) can comprise a substage ii-2) during which the protruding current collector of the positive electrode is electrically connected to the lower part of the main body of the external casing, preferably by welding (e.g., using laser welding by transparency), brazing, diffusion brazing or clamped or screwed contacts. The technique of laser welding by transparency is conventionally used in processes for the preparation of conventional non-hybrid symmetrical supercapacitors. It makes it possible to electrically connect all the turns of the coiled element.

Substages ii-1) and ii-2) may be simultaneous or separate.

Thus, on conclusion of stage ii) or of substages ii-1) and/or ii-2), the protruding current collector of the negative electrode is located in the upper part of the main body of the external casing and the protruding current collector of the positive electrode is located in the lower part of the main body of the external casing.

It is obvious that the invention is not limited to the embodiment as described above. This is because it can be entirely envisaged to reverse the upper and the lower parts of the main body of the external casing and in particular to obtain a configuration in which the protruding current collector of the negative electrode is located in the lower part of the main body of the external casing and the protruding current collector of the positive electrode is located in the upper part of the main body of the external casing.

As such, in the description which will follow below, when reference is made to upper and lower parts of the main body of the external casing, it is considered that, on conclusion of stage ii), the protruding current collector of the negative electrode is located in the upper part of the main body of the external casing and the protruding current collector of the positive electrode is located in the lower part of the main body of the external casing. However, it is possible to employ the reverse configuration.

The part made of conducting material is preferably composed of a conducting material identical to that of the current collector of the negative electrode, in particular is made of copper.

The part made of conducting material can be configured in order to close, in leaktight and temporary fashion, at least in part, indeed even completely, the upper part of the main body of the external casing of the supercapacitor (e.g., on conclusion of stage iv)).

The part made of conducting material can be capable of passing, in leaktight manner, through the upper part of the main body of the external casing, in particular via a leaktightness means (e.g., leaktightness seal) which ensures the electrical insulation between the part made of conducting material and the external casing.

The lower and upper parts of the main body of the external casing can be two separate elements. Stage ii) then comprises a substage ii-3) during which said parts are connected mechanically in order to form the main body of the external casing, in particular by welding.

Substage ii-3) can be carried out before or after substages ii-1) and ii-2). It is preferably carried out after substages ii-1) and ii-2). This thus makes it possible to more easily and freely carry out substages ii-1) and ii-2).

The lower part of the main body of the external casing is generally composed of an electrochemically conducting material compatible with that of the current collector of the positive electrode, in particular made of aluminium. The supercapacitor can additionally comprises a lid, integral with or separate from said lower part, said lid being composed of an electrochemically conducting material compatible with that of the current collector of the positive electrode, in particular made of aluminium. This lid makes it possible to hermetically close the main body of the external casing of the supercapacitor at its lower part.

The upper part of the main body of the external casing is generally composed of an electrochemically conducting material compatible with that of the current collector of the positive electrode, in particular made of aluminium.

However, it is possible to use an electrochemically conducting material compatible with that of the current collector of the negative electrode, in particular made of copper. This is a more expensive solution (e.g., use of copper vs aluminium). Furthermore, it necessitates carrying out substage ii-3) via a linkage different from welding (e.g., crimping, adhesive bonding, and the like), in order to make possible the electrical insulation of the lower and upper parts of the main body of the external casing.

In this embodiment, the part made of conducting material can form an integral part of the upper part of the main body of the external casing.

On conclusion of stage ii), the lower part of the main body of the external casing is hermetically and preferably definitively closed.

The organic solvent of the non-aqueous liquid electrolyte makes it possible to optimize the transportation and the dissociation of the ions of the alkali metal M1.

It can comprise one or more polar aprotic compounds chosen from linear or cyclic carbonates, linear or cyclic ethers, linear or cyclic esters, linear or cyclic sulphones, sulphamides and nitriles.

The organic solvent preferably comprises at least two carbonates chosen from ethylene carbonate, propylene carbonate, dimethyl carbonate, diethyl carbonate and ethyl methyl carbonate.

The salt of the alkali metal M1 used in the non-aqueous liquid electrolyte can be chosen from M1PF₆, M1AsF₆, M1ClO₄, M1BF₄, M1C₄BO₈, M1(C₂F₅SO₂)₂N, M1[(C₂F₅)₃PF₃], M1CF₃SO, M1CHSO₃, M1N(SO₂CF₃)₂ and M1N(SO₂F)₂, M12SO₄, M1NO₃, M13PO₄, M12CO₃, M1FSI (FSI=bis(fluorosulphonyl)imide), M1BETI (BETI=bis(perfluoroethanesulphonyl)imide, also known as PFSI) and M1TFSI (TFSI=bis(trifluoromethanesulphonyl)imide), M1 being as defined in the invention.

On conclusion of the impregnation stage iii), the non-aqueous liquid electrolyte impregnates the coiled element and optionally the solid mass when stage iv) is carried out before stage iii).

During stage iii), an excess of non-aqueous liquid electrolyte is preferably used, so as to completely bathe the cylindrical coiled element and the solid mass. This thus makes it possible to improve the dissolution of the alkali metal M1.

On conclusion of stage iii) or of stage iv), the solid mass is thus found in direct ionic contact with the cylindrical coiled element.

Stage iv) makes it possible to position the solid mass at the core of the cylindrical coiled element. It is carried out before or after the stage of impregnation iii) of the cylindrical coiled element by the non-aqueous liquid electrolyte.

Stage iv) is preferably carried out after stage iii) (i.e., further downstream in the process of the invention). This thus makes it possible to reduce the number of stages carried out under a controlled atmosphere. This is because the alkali metal M1 is generally handled under a humidity-controlled atmosphere, in particular under an inert atmosphere, during stage iv) and the subsequent stages.

The alkali metal M1 is preferably chosen from lithium, sodium and potassium and more preferably lithium.

In the present invention, the expression “solid mass comprising said alkali metal M1” means a mass in the solid form. In other words, the mass is not in the pulverulent form. This also means that the alkali metal M1 or any other chemical element present in the solid mass is in the solid and non-pulverulent form.

The solid mass preferably has a height which is greater than or equal to that of the cylindrical coiled element. This thus makes it possible to provide ions of the alkali metal M1 over the entire height of the electrodes of the cylindrical coiled element during stage v).

The solid mass comprising said alkali metal M1 is preferably in the form of a hollow cylinder or in the form of a solid bar or of a solid rod, in particular one which is cylindrical.

The bar or the rod can have a diameter ranging from 1 to 50 mm approximately and preferably ranging from 5 to 20 mm approximately.

The bar or the rod can have a diameter as close as possible to the diameter of the central free volume of the cylindrical coiled element. This thus makes it possible to minimize the distance to be traveled by the ions of the alkali metal M1.

The solid mass can consist solely of said alkali metal M1 or can additionally comprise another conducting material, such as copper.

When the solid mass consists solely of said alkali metal M1, it is preferably in the form of a solid bar or of a solid rod of said alkali metal M1.

When the solid mass additionally comprises a conducting material, it can be in the form of a hollow cylinder comprising an internal layer of said conducting material and an external layer of said alkali metal M1 surrounding said internal layer or in the form of a solid cylinder comprising a central core of said conducting material and a layer of said alkali metal M1 surrounding said central core.

The conducting material of the internal layer or of the central core can be in the form of a foam of conducting material (porous conducting material). This thus makes it possible to deposit the alkali metal M1 within the foam of conducting material and to increase the surface area for exchange between the alkali metal M1 and the non-aqueous liquid electrolyte during stage iii) or iv).

The insertion according to stage iv) is preferably carried out by the upper part of the main body of the external casing.

On conclusion of stage iv) [if stage iv) is carried out after stage iii)] or of stage iii) [if stage iv) is carried out before stage iii)], the upper part of the main body of the external casing is preferably hermetically and temporarily closed.

The temporary closing thus makes it possible to be able to carry out stage vi) of withdrawal of the solid mass, once the initial formation stage v) has been carried out.

Stage v) makes it possible to intercalate ions of the alkali metal M1 into the negative electrode and thus to bring the negative electrode to a lower potential.

During stage v), the solid mass can be mechanically and electrically connected to the part made of conducting material as defined above (also known as “first part made of conducting material”) or to another part made of conducting material (also known as “second part made of conducting material”), in particular made of copper or of copper alloy (e.g., brass).

The second part made of conducting material is configured in order to ensure the direct or indirect electrical connection with the first part made of conducting material. This thus makes it possible to electrically connect the solid mass to the negative electrode via the two parts made of conducting material.

The electrical connection between the solid mass and the negative electrode can thus be made via the first part made of conducting material or the first and second parts made of conducting material.

Generally, stages iv) and v) are concomitant. In other words, the electrical connection between the solid mass and the negative electrode takes place during the insertion of the solid mass into the central free volume of the cylindrical coiled element, in particular when the solid mass is completely inserted into the central free volume of the cylindrical coiled element. The electrical connection of stage v) thus takes place by electrical contact of the solid mass with the first part made of conducting material or by electrical contact of the second part made of conducting material with the first part made of conducting material, the first part made of conducting material being itself in electrical contact with the protruding current collector of the negative electrode.

As soon as this contact this made, this forms a short circuit between the negative electrode of the coiled element and the solid mass, bringing about the migration of the ions of the alkali metal M1 towards the negative electrode.

The electrical connection between the first and second parts made of conducting material can be direct or indirect (i.e., direct or indirect short circuit).

A direct electrical connection implies that the two parts are in mechanical and electrical contact.

The direct contact makes it possible (once the main body of the external casing is closed) to carry out stage v) without specific precautions, except for preventing contact between the positive and negative poles.

The type of direct linkage between the first part made of conducting material and the second part made of conducting material can involve screwing with electrical support and leaktight seal, pinching, clip-fastening or ¼-turn locking.

The indirect electrical connection involves, for example, the application between said parts of a difference in potential, of a circulation of current or the presence of a controlled resistor. This makes it possible to better control the process of intercalation of the ions of the alkali metal M1 on the negative electrode during stage v).

This embodiment involves the command of the circulation of current in the controlled resistor and thus the satisfactory initial proportioning of the resistor, or the use of charge/discharge racks or of controlled supplies in order to ensure the potentials or the passages of current.

The advantage of such an embodiment is to be able to monitor the change in the potential of the negative electrode vs the positive electrode in order to determine the end of stage v).

The type of indirect linkage between the first part made of conducting material and the second part made of conducting material can involve:
an insulating intermediate part (e.g., made of elastomeric or thermoplastic material) located between the two parts made of conducting material and being mechanically connected to said parts made of conducting material, and
an electrical connection between the two parts made of conducting material using an external electrical circuit (charger/discharger), an external resistor or an external short circuit switch; or
a controlled-resistivity intermediate part located between the two parts made of conducting material and being mechanically connected to said parts made of conducting material.

The insulating intermediate part provides the leaktightness between the two parts made of conducting material.

In the case of the use of a controlled-resistivity intermediate part (also known as “controlled-resistance spacer”), the electrical connection between the two parts made of conducting material is made via the electrical resistance provided by the controlled-resistivity intermediate part.

This controlled-resistivity intermediate part also provides the leaktightness between the two parts made of conducting material (e.g., part made of elastomeric or thermoplastic material).

The second part made of conducting material can be configured in order to close, in leaktight (i.e., hermetic) and temporary fashion, at least in part, indeed even completely, the upper part of the main body of the external casing of the supercapacitor (e.g., on conclusion of stage iv)).

According to a particularly preferred embodiment of the invention, the combination of the first and second parts made of conducting material (and optionally of the insulating or controlled-resistivity intermediate part) completely closes the upper part of the main body of the external casing of the supercapacitor (e.g., on conclusion of stage iv)).

In particular, the first part made of conducting material comprises a central free volume which makes possible the passage and the insertion of the solid mass into the central free volume of the cylindrical coiled element [stage iv)] and the second part made of conducting material is configured in order to completely cover or close the central free volume of the first part on conclusion of stage iv) (i.e., when the insertion is completed). Thus, during stage iv), the solid mass is inserted into the central free volume of the cylindrical coiled element via the central free volume of the first part made of conducting material. At the end of the insertion, the combination of the first and second parts made of conducting material closes, in leaktight and temporary fashion, the upper part of the main body of the external casing.

When the second part made of conducting material is configured in order to completely cover the central free volume of the first part, the latter can have a diameter or a length greater than that of the central free volume.

According to a particularly preferred embodiment of the invention, the second part made of conducting material is also configured in order to act as purchase means. This thus makes it possible to facilitate the withdrawal of the solid mass during stage vi).

When the second part made of conducting material is configured in order to completely close the central free volume of the first part without, however, covering it, the second part made of conducting material can be configured in order to be completely inserted into the central free volume.

It can, for example, be in the form of a collar surrounding the solid mass, said collar being in mechanical and electrical contact with the first part made of conducting material.

In this embodiment, the solid mass can in addition be connected mechanically to a purchase means made of insulating material. This thus makes it possible to facilitate the withdrawal of the solid mass during stage vi).

The insulating intermediate part (respectively the controlled-resistivity intermediate part) can also comprise a central free volume which makes possible the passage and the insertion of the solid mass into the central free volume of the coiled element [stage iv)] and the second part made of conducting material is configured in order to completely cover or close the central free volume of the insulating intermediate part (respectively of the controlled-resistivity intermediate part) on conclusion of stage iv) (i.e., when the insertion is completed). Thus, during stage iv), the solid mass is inserted into the central free volume of the cylindrical coiled element via the central free volume of the insulating intermediate part (respectively of the controlled-resistivity intermediate part) and of the first part made of conducting material. At the end of the insertion, the combination of the first and second parts made of conducting material (and optionally of the insulating or controlled-resistivity intermediate part) closes, in leaktight and temporary fashion, the upper part of the main body of the external casing of the supercapacitor.

In order to facilitate the insertion of the solid mass, the central free volume of the first part made of conducting material (respectively the central free volume of the insulating or controlled-resistivity intermediate part) has dimensions (e.g., a diameter) which are substantially identical to those (e.g., to the diameter) of the central free volume of the cylindrical coiled element.

The second part made of conducting material is preferably of rectangular, square or cylindrical shape, in particular with a shape identical to that of the first part made of conducting material, so as to improve the electrical connection and contact between the first and second parts made of conducting material.

Other means for leaktightness between the first and second parts made of conducting material than the insulating or controlled-resistivity intermediate part can be used to provide leaktight and temporary closing of the upper part of the main body of the casing.

Stage v) can last a sufficient time to make it possible to charge the negative electrode with ions of the alkali metal M1 to a value ranging from 70 to 95% approximately of the total charge of the electrode and preferably to a value ranging from 80 to 90% approximately of the total charge of the electrode.

If the negative electrode is insufficiently charged, it becomes unstable and its potential rises again with time.

If the negative electrode is excessively charged, it can get to charge saturation in operation and deteriorate.

According to one embodiment of the invention, stage v) lasts at least 24 hours and preferably at least 7 days.

Stage v) can be carried out at ambient temperature (i.e., 20-25° C.) or at a higher temperature than ambient temperature (for example between 25° C. and 70° C.) in order to increase the ionic diffusion and to accelerate the formation of the negative electrode, and thus to accelerate the consumption of the solid mass in the liquid electrolyte used.

During stage vi), the solid mass is withdrawn from the cylindrical coiled element.

Thus, on conclusion of stage vi), the supercapacitor no longer comprises alkali metal M1. Furthermore, the gases created during stage v) escape from the inside of the supercapacitor, on the one hand, to make it possible for the central volume to again be free and, on the other hand, to make it possible to collect the pressure of the gases emitted during the subsequent ageing of the supercapacitor and thus to prevent or limit deformations of the external casing.

Stage vii) is preferably carried out using a closure plug, for example of rivet type, a lid, a weld (for example by the friction stir welding technique) or a cap optionally equipped with a valve for combating excess pressure. Stage vii) can be carried out according to any other method known to a person skilled in the art.

This closure stage is generally definitive, that is to say that, on conclusion of stage vii), the supercapacitor is functional.

In the present invention, the term “functional supercapacitor” means that the supercapacitor is ready to be tested and/or controlled, then packaged and finally sold.

The closure plug is preferably configured in order to close the central free volume of the first part made of conducting material.

The process can additionally comprise, after stage vi) or during stage vi), a stage vi′) of emptying the surplus non-aqueous liquid electrolyte present in the main body of the external casing.

This stage vi′) thus makes it possible to increase the central free volume of the coiled element after the withdrawal of the solid mass according to stage vi).

Another subject-matter of the invention is a cylindrical alkali metal-ion hybrid supercapacitor, characterized in that it is obtained according to the process of the invention.

This is because, on conclusion of stage vi), the cylindrical alkali metal-ion hybrid supercapacitor does not contain any residue of the alkali metal M1. A portion of the alkali metal M1 of the solid mass has been intercalated into the negative electrode during the initial formation stage [stage v)], and the other portion (i.e., the remaining portion) of the alkali metal M1 of the solid mass has been withdrawn during the following stage vi).

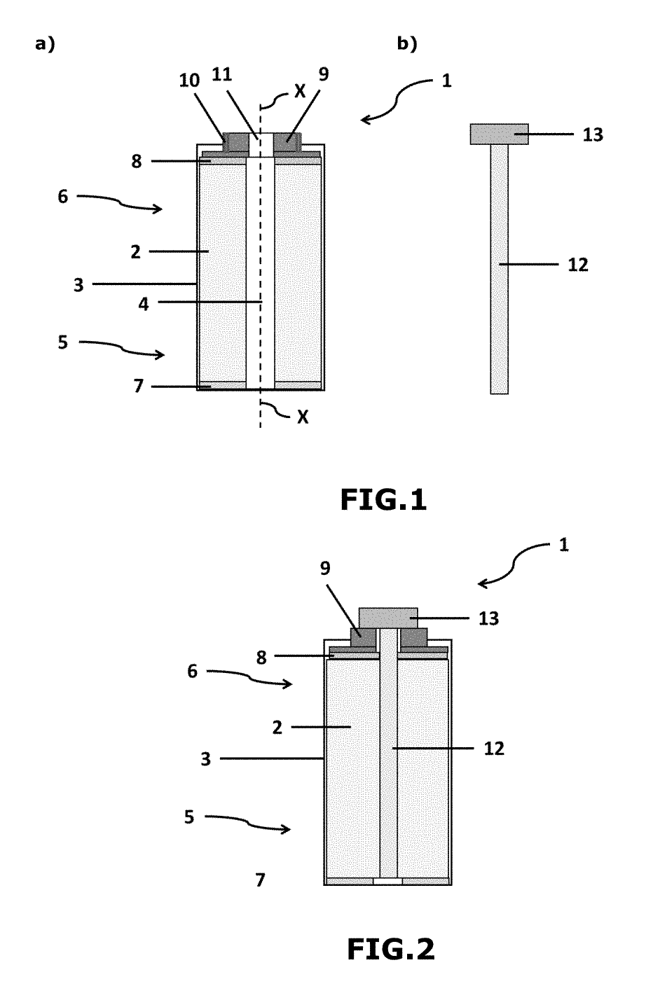

Several embodiments of the invention are described below with reference to FIGS. 1 to 6.

FIG. 1 represents a view in section along a transverse axis of the supercapacitor of the present invention as obtained on conclusion of stage ii) (FIG. 1a) and of the solid mass comprising said alkali metal M1 before its insertion during stage iv) into the central free volume of the cylindrical coiled element (FIG. 1b).

In particular, FIG. 1a illustrates a cylindrical alkali metal-ion hybrid supercapacitor 1 comprising at least one cylindrical coiled element 2 and an external casing 3 containing a main body intended to receive said cylindrical coiled element 2.

The cylindrical coiled element 2 comprises at least one positive electrode, at least one negative electrode and at least one separator intercalated between the positive and negative electrodes, the positive and negative electrodes and the separator being wound together as turns around an axis X-X, the cylindrical coiled element having a central free volume 4 along the axis X-X. The positive electrode comprises at least one positive electrode active material capable of intercalating and of deintercalating ions of an alkali metal M1 and/or capable of adsorbing and of desorbing ions of an alkali metal M1, said positive electrode being deposited on a positive electrode current collector, and the negative electrode comprises at least one negative electrode active material capable of intercalating and of deintercalating ions of an alkali metal M1, said negative electrode being deposited on a negative electrode current collector.

The main body of the external casing 3 has a lower part 5 and an upper part 6.

On conclusion of stage ii), the cylindrical coiled element 2 is inserted into the main body of the external casing 3. Furthermore, the protruding current collector of the positive electrode 7 is located in the lower part 5 of the main body of the external casing and the protruding current collector of the negative electrode 8 is located in the upper part 6 of the main body of the external casing 3. The lower part of the main body of the external casing is hermetically closed.

Stage ii) additionally comprises a substage ii-1) during which the protruding current collector of the negative electrode 8 is electrically connected to a first part made of conducting material 9, preferably by welding (e.g., using laser welding by transparency), brazing, diffusion brazing or clamped or screwed contacts. The technique of laser welding by transparency makes it possible to electrically connect all the turns of the coiled element.

Stage ii) additionally comprises a substage ii-2) during which the protruding current collector of the positive electrode 7 is electrically connected to the lower part 5 of the main body of the external casing 3, preferably by welding (e.g., using laser welding by transparency), brazing, diffusion brazing or clamped or screwed contacts. The technique of laser welding by transparency is conventionally used in processes for the preparation of conventional non-hybrid symmetrical supercapacitors. It makes it possible to electrically connect all the turns of the coiled element.

The first part made of conducting material 9 is preferably composed of a conducting material identical to that of the current collector of the negative electrode, in particular made of copper or of copper alloy.

In FIG. 1a, the first part made of conducting material 9 partially closes, in leaktight and temporary fashion, the upper part 6 of the main body of the external casing 3 of the supercapacitor.

The part made of conducting material 9 passes, in leaktight manner, through the upper part of the main body of the external casing 3, in particular via a leaktight means 10 (e.g., leaktightness seal), which ensures the electrical insulation between the part made of conducting material 9 and the external casing 3.

The first part made of conducting material 9 comprises a central free volume 11 making possible the passage and the insertion of a solid mass 12 comprising an alkali metal M1 into the central free volume 4 of the coiled element 2 (stage iv)).

The lower 5 and upper 6 parts of the main body of the external casing 3 can be two separate elements. Stage ii) then comprises a substage ii-3) during which said parts are mechanically connected in order to form the main body of the casing, in particular by welding.

The lower part 5 of the main body of the casing 3 is composed of an electrochemically conducting material compatible with that of the current collector of the positive electrode, in particular made of aluminium.

The upper part 6 of the main body of the casing is composed of an electrochemically conducting material compatible with that of the current collector of the positive electrode, in particular made of aluminium.

FIG. 1b represents the solid mass 12 comprising an alkali metal M1 which it is desired to insert according to stage iv) into the central free volume 4 of the coiled element via the central free volume 11 of the first part made of conducting material 9. The alkali metal M1 is preferably chosen from lithium, sodium and potassium and more preferably lithium. FIG. 1b illustrates a solid mass 12 having a height greater than that of the coiled element 2. This thus makes it possible to provide alkali metal M1 over the entire height of the electrodes of the coiled element 2 during stage iv).

The solid mass 12 illustrated in FIG. 1b consists solely of said alkali metal M1 and is provided in the form of a solid bar or of a solid rod, in particular one which is cylindrical.

The bar or the rod 12 can have a diameter ranging from 1 to 50 mm approximately and preferably ranging from 5 to 20 mm approximately.

In order to make possible the electrical connection of the solid mass 12 with the negative electrode according to stage v), the solid mass 12 is mechanically and electrically connected to a second part made of conducting material 13, in particular made of copper or of copper alloy. This second part made of conducting material 13 is configured in order to ensure the electrical connection with the first part made of conducting material 9. This thus makes it possible to electrically connect the solid mass 12 with the negative electrode via the two parts made of conducting material 9 and 13.

FIG. 2 illustrates a view in section along a transverse axis of the supercapacitor of the present invention as obtained on conclusion of stage iv) [or stage iii), if stage iv) of insertion of the solid mass takes place before said stage iii)].

The second part made of conducting material 13 is configured in order to completely cover or close the central free volume 11 of the first part 9 on conclusion of stage iv) (i.e., when the insertion is completed). Thus, during stage iv), the solid mass 12 is inserted into the central free volume 4 of the coiled element 2 via the central free volume 11 of the first part made of conducting material 9. At the end of the insertion, the first part made of conducting material 9 is in mechanical and electrical contact with the second part made of conducting material 13 and the combination of the first and second parts made of conducting material 9 and 13 completely closes, in leaktight and temporary fashion, the upper part 6 of the main body of the external casing 3.

FIG. 2 illustrates a direct electrical connection between the first and second parts made of conducting material 9 and 13.

In order to facilitate the insertion of the solid mass 12, the central free volume 11 of the first part made of conducting material 9 has dimensions (e.g., a diameter) substantially identical to those of the central free volume 4 of the coiled element 2.

The second part made of conducting material 13 is preferably of rectangular, square or cylindrical shape, in particular with a shape identical to that of the first part made of conducting material 9, so as to improve the contact and the connection between the first and second parts made of conducting material 9 and 13.

Means for leaktightness between the first and second parts made of conducting material 9 and 13 can be used to ensure leaktight and temporary closing of the upper part 6 of the main body of the external casing 3.

On conclusion of stage iv), the combination of the first and second parts made of conducting material completely closes the upper part of the main body of the casing.

Furthermore, stage iv) makes possible the electrical connection of the solid mass 12 to the extending current collector of the negative electrode 8 (i.e., concomitant stages iv) and v)).

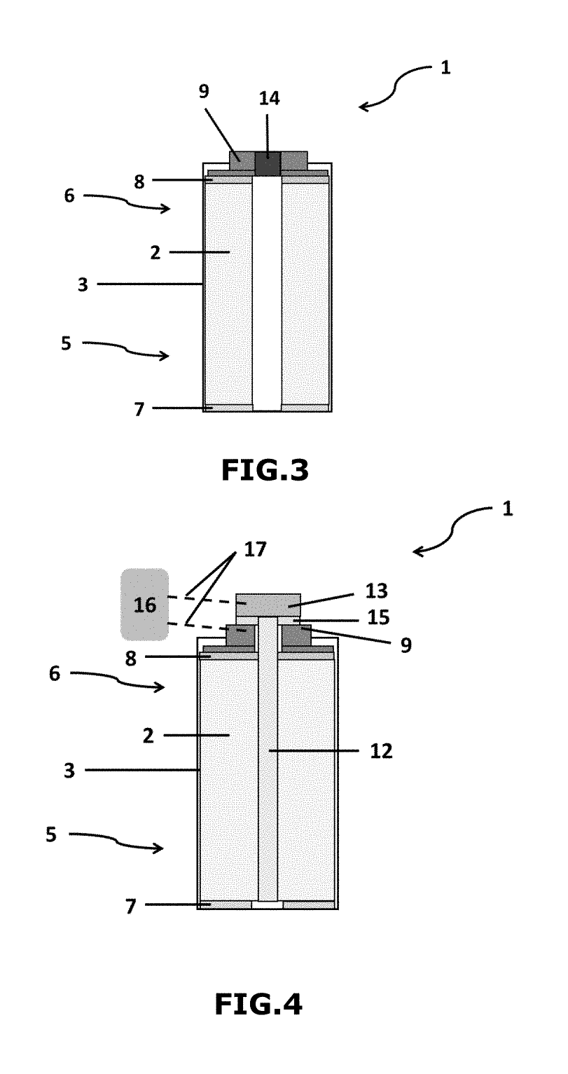

FIG. 3 represents a view in section along a transverse axis of the supercapacitor of the present invention as obtained on conclusion of stage vii). The hermetic (and definitive) closure of the supercapacitor is carried out by virtue of a closure plug 14, for example of rivet type, a lid, a weld (for example by the friction stir welding technique) or a cap optionally equipped with a valve for combating excess pressure. This closure plug 14 is configured in order to close the central free volume 11 of the first part made of conducting material 9.

FIG. 4 represents an embodiment of the invention in which the electrical connection between the first and second parts made of conducting material 9 and 13 is indirect.

In this embodiment, the type of indirect linkage between the first part made of conducting material 9 and the second part made of conducting material 13 involves an intermediate part 15 located between the two parts made of conducting material and being mechanically connected to said parts made of conducting material.

This intermediate part 15 is an insulating part (e.g., made of elastomeric or thermoplastic material).

The electrical connection between the two parts made of conducting material 9 and 13 is made using an external electrical circuit 16 (charger/discharger) and electrical linkages 17. The insulating intermediate part 15 ensures the leaktightness between the two parts made of conducting material 9 and 13.

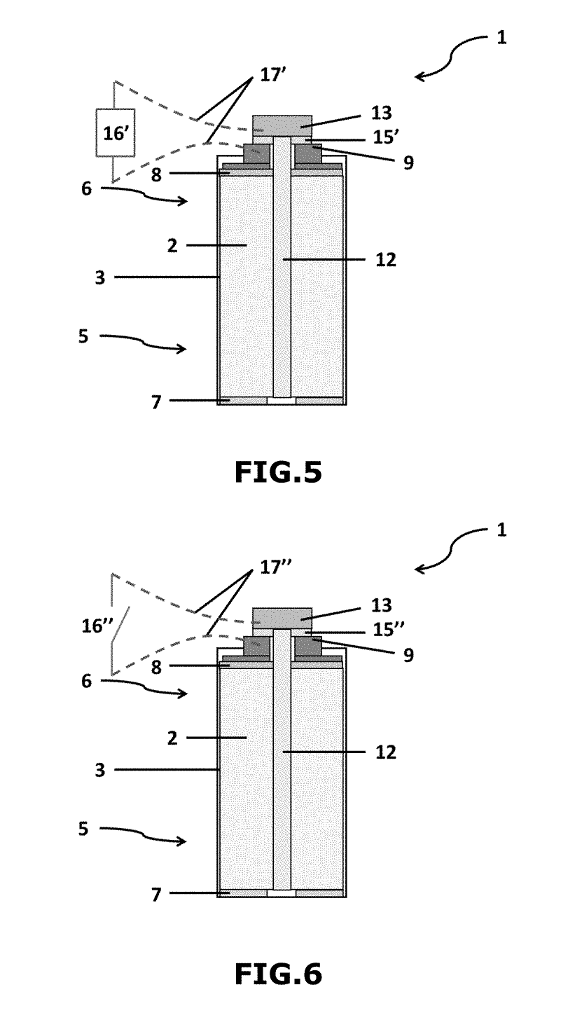

FIG. 5 represents an embodiment of the invention in which the electrical connection between the first and second parts made of conducting material 9 and 13 is indirect.

In this embodiment, the type of indirect linkage between the first part made of conducting material 9 and the second part made of conducting material 13 involves an intermediate part 15′ located between the two parts made of conducting material and being mechanically connected to said parts made of conducting material.

This intermediate part 15′ is an insulating part (e.g., made of elastomeric or thermoplastic material).

The electrical connection between the two parts made of conducting material 9 and 13 is made using an external resistor 16′ (charger/discharger) and electrical linkages 17′. The insulating intermediate part 15′ ensures the leaktightness between the two parts made of conducting material 9 and 13.

FIG. 6 represents an embodiment of the invention in which the electrical connection between the first and second parts made of conducting material 9 and 13 is indirect.

In this embodiment, the type of indirect linkage between the first part made of conducting material 9 and the second part made of conducting material 13 involves an intermediate part 15″ located between the two parts made of conducting material and being mechanically connected to said parts made of conducting material.

This intermediate part 15″ is an insulating part (e.g., made of elastomeric or thermoplastic material).

The electrical connection between the two parts made of conducting material 9 and 13 is made using an external short circuit switch 16″ and electrical linkages 17″. The insulating intermediate part 15″ ensures the leaktightness between the two parts made of conducting material 9 and 13.

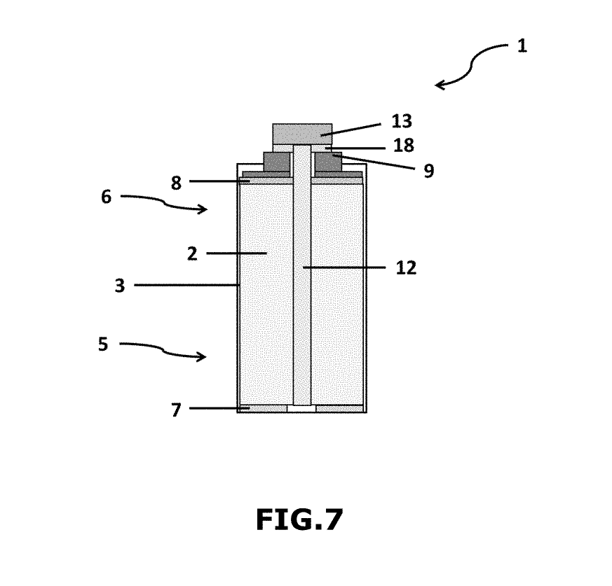

FIG. 7 represents an embodiment of the invention in which the electrical connection between the first and second parts made of conducting material 9 and 13 is indirect.

In this embodiment, the type of indirect linkage between the first part made of conducting material 9 and the second part made of conducting material 13 involves an intermediate part 18 located between the two parts made of conducting material and being mechanically connected to said parts made of conducting material.

This intermediate part 18 is a controlled-resistivity part (e.g., made of elastomeric or thermoplastic material).

The electrical connection between the two parts made of conducting material 9 and 13 is made via the electrical resistance provided by the intermediate part 18 (also known as “controlled-resistance spacer”).

The intermediate part 18 also ensures the leaktightness between the two parts made of conducting material 9 and 13.

1. Process for the preparation of a cylindrical alkali metal-ion hybrid supercapacitor comprising at least one cylindrical coiled element and an external casing containing a main body intended to receive said cylindrical coiled element, said process comprising at least the following stages:
i) the preparation of a cylindrical coiled element centred on an X-X axis comprising at least one positive electrode, at least one negative electrode and at least one separator intercalated between the positive and negative electrodes, the positive and negative electrodes and the separator being wound together as turns around said X-X axis, the cylindrical coiled element having a central free volume along the X-X axis, it being understood that:
the positive electrode comprises at least one positive electrode active material capable of intercalating and of deintercalating ions of an alkali metal M1 and/or capable of adsorbing and of desorbing ions of an alkali metal M1, said positive electrode being deposited on a positive electrode current collector, and
said negative electrode comprises at least one negative electrode active material capable of intercalating and of deintercalating ions of an alkali metal M1, said negative electrode being deposited on a negative electrode current collector,
ii) the insertion of the cylindrical coiled element into a main body of an external casing intended to receive said cylindrical coiled element,
iii) the impregnation of the cylindrical coiled element by a non-aqueous liquid electrolyte comprising a salt of said alkali metal M1 and an organic solvent,
wherein said process additionally comprises:
iv) the insertion of a solid mass comprising said alkali metal M1 into the central free volume of the cylindrical coiled element, before or after stage iii),
v) the electrical connection of the solid mass with the negative electrode, so as to obtain a short circuit and to intercalate ions of said alkali metal M1 into the negative electrode of the cylindrical coiled element,
vi) the withdrawal of the solid mass from the cylindrical coiled element, and
vii) the hermetic closure of the main body of the external casing, in order to obtain the cylindrical alkali metal-ion hybrid supercapacitor.

2. Process according to claim 1, characterized in that wherein stage i) comprises
a substage i-1) of assembling at least one positive electrode, at least one negative electrode and at least one separator intercalated between the negative electrode and the positive electrode, and
a substage i-2) of winding the assemblage spirally around an axis X-X in order to form a cylindrical coiled element having a central free volume along the axis X-X.

3. Process according to claim 1, wherein the active material of the negative electrode comprises graphite and optionally a material chosen from activated carbon, graphene, carbide-derived carbon, hard carbon and soft carbon.

4. Process according to claim 1, wherein the active material of the positive electrode comprises a porous carbon-based material or a transition metal oxide.

5. Process according to claim 1, wherein the active material of the positive electrode comprises activated carbon and optionally a material chosen from graphite, graphene, carbide-derived carbon, hard carbon and soft carbon.

6. Process according to claim 1, wherein the current collector of the negative electrode is made of copper.

7. Process according to claim 1, wherein the current collector of the positive electrode is made of aluminium.

8. Process according to claim 1, wherein the alkali metal M1 is chosen from lithium, sodium and potassium.

9. Process according to claim 1, wherein the solid mass consists solely of said alkali metal M1 and it is in the form of a solid bar or of a solid rod of said alkali metal M1.

10. Process according to claim 1, wherein stage v) lasts a sufficient time to make it possible to charge the negative electrode with ions of alkali metal M1 to a value ranging from 70 to 95% of the total charge of the electrode.

11. Process according to claim 1, wherein said process additionally comprises, after stage vi) or during stage vi), a stage vi′) of emptying the surplus non-aqueous liquid electrolyte present in the main body of the external casing.

12. Process according to claim 1, wherein stage vii) is carried out using a closure plug, a lid, a weld or a cap.

13. Process according to claim 1, wherein the main body of the external casing has a lower part and an upper part and stage ii) is carried out so as to position the protruding current collector of the positive electrode in the lower part of the main body of the external casing and the protruding current collector of the negative electrode in the upper part of the main body of the external casing.

14. Process according to claim 13, wherein stage ii) comprises
a substage ii-1) during which the protruding current collector of the negative electrode, at one end of said coiled element, is electrically connected to a part made of conducting material.

15. Process according to claim 13, wherein stage ii) comprises
a substage ii-2) during which the protruding current collector of the positive electrode, at one end of said coiled element, is electrically connected to the lower part of the main body of the external casing.

16. Process according to claim 13, wherein, on conclusion of stage ii), the lower part of the main body of the external casing is hermetically and definitively closed and the insertion according to stage iv) is carried out by the upper part of the main body of the external casing.

17. Process according to claim 14, wherein the part made of conducting material is composed of a conducting material identical to that of the current collector of the negative electrode.

18. Process according to claim 14, wherein the part made of conducting material is configured in order to close, in leaktight and temporary fashion, at least in part, indeed even completely, the upper part of the main body of the external casing of the supercapacitor.

19. Process according to claim 14, wherein the part made of conducting material is capable of passing, in leaktight manner, through the upper part of the main body of the external casing.

20. Process according to claim 14, wherein, during stage v), the solid mass is mechanically and electrically connected to the part made of conducting material and known as “first part made of conducting material” or to another part made of conducting material known as “second part made of conducting material”, said second part made of conducting material being configured in order to ensure the direct or indirect electrical connection with the first part made of conducting material.

21. Process according to claim 20, wherein, on conclusion of stage iv), the combination of the first and second parts made of conducting material completely closes the upper part of the main body of the external casing.

22. Process according to claim 20, wherein the first part made of conducting material comprises a central free volume which makes possible the passage and the insertion of the solid mass into the central free volume of the cylindrical coiled element and the second part made of conducting material is configured in order to completely cover or close the central free volume of the first part on conclusion of stage iv).

23. Cylindrical alkali metal-ion hybrid supercapacitor, wherein it is obtained according to a process as defined in any one of the preceding claims.
